(19) United States
(12) Patent Application Publication
(10) Pub. No.: US 2018/0306499 A1
(43) Pub. Date: Oct. 25, 2018

(54) Methods for Gas-Vapor Separation using a Three-Phased Scouring Heat Exchanger

(71) Applicants: Larry Baxter, Orem, UT (US); Christopher Hoeger, Provo, UT (US); Skyler Chamberlain, Provo, UT (US); David Frankman, Provo, UT (US); Aaron Sayre, Spanish Fork, UT (US); Kyler Stitt, Lindon, UT (US); Eric Mansfield, Spanish Fork, UT (US); Stephanie Burt, Provo, UT (US); Nathan Davis, Bountiful, UT (US)

(72) Inventors: Larry Baxter, Orem, UT (US); Christopher Hoeger, Provo, UT (US); Skyler Chamberlain, Provo, UT (US); David Frankman, Provo, UT (US); Aaron Sayre, Spanish Fork, UT (US); Kyler Stitt, Lindon, UT (US); Eric Mansfield, Spanish Fork, UT (US); Stephanie Burt, Provo, UT (US); Nathan Davis, Bountiful, UT (US)

(21) Appl. No.: 15/493,646

(22) Filed: Apr. 21, 2017

(51) Int. Cl. F25J 3/08; B01D 53/00

(52) U.S. Cl. CPC F25J 3/08; B01D 53/002; F25J 2205/20; F25J 2205/32; F25J 2205/84; F25J 2270/90; F25J 2210/60; F25J 2210/70; F25J 2220/66; F25J 2220/68; F25J 2220/64; F25J 2205/40

(57) ABSTRACT

A method for removing a vapor from a carrier gas is disclosed. A heat exchanger is provided. A coolant is provided to the coolant side. A slurry is provided to the process side. The slurry comprises a contact liquid and scouring solids. The carrier gas is provided to the heat exchanger, the carrier gas comprising a vapor. A portion of the vapor desublimates, condenses, absorbs, or reacts such that the portion of the vapor solidifies to form a product solid. At least a portion of the product solid deposits as a foulant on an outer surface of the coolant side and is scoured with the scouring solids to remove the foulant from the outer surface of the coolant side. A vapor-depleted carrier gas is removed from the heat exchanger. The slurry and product solid from the heat exchanger. In this manner, the vapor is removed from the carrier gas.

This invention was made with government support under DE-FE0028697 awarded by The Department of Energy. The government has certain rights in the invention.

### FIELD OF THE INVENTION

This invention relates generally to separating a vapor from a carrier gas. More particularly, we are interested in removing carbon dioxide and other condensable compounds from flue gas and other industrial gases.

### BACKGROUND

Removal of carbon dioxide, other acid gases, and other condensable contaminants from flue gas and other industrial gases is a young, but significant industry. Vapor-gas separations are a challenge in any industry, but carbon dioxide is a chemical “chameleon.” With no permanent dipole moment, but with the ability to develop an induced dipole, carbon dioxide is energetically content in almost any gas or liquid with which it mixes. Current cutting-edge techniques for cryogenic gas-vapor separation can separate carbon dioxide, other acid gases, and other condensable contaminants, but the energy costs are significant and the systems are extremely complex. A simple method, preferably using a single unit operation with minimal energy costs, for separating these types of vapors from their carrier gases is needed.

Gas-liquid-solid fluidization is defined by Muroyama and Fan in AIChE Journal, Volume 31, Issue 1, as “an operation in which a bed of solid particles is suspended in gas and liquid media due to the net drag force of the gas and/or liquid flowing opposite to the net gravitational force or buoyancy force on the particles.” Gas-liquid-solid fluidization is useful for various reactions and direct-contact heat exchange processes using fluidized beds or plug flows. However, no gas-liquid-solid fluidization process has been applied for use in an indirect-contact heat exchanger for removing a vapor component from a carrier gas.

United States patent publication number 3991816, to Klaren teaches an apparatus for carrying out a physical and/or chemical process, such as a heat exchanger. The apparatus consists of a heat exchanger with vertically oriented pipes and a recirculating fluidized granular material that scours the pipes as the fluidizing material is heated or cooled. The present disclosure differs from this disclosure in that the heat exchanger is limited to a vertical orientation and positive vertical direction flow, is used for cooling only the fluidizing medium, and cannot be used to cool a carrying liquid that will then cool and solidify a vapor component out of a gas that is also passed through the heat exchanger. In other words, this disclosure is not able to cause gas-vapor separations. This disclosure is pertinent and may benefit from the devices disclosed herein and is hereby incorporated for reference in its entirety for all that it teaches.

United States patent publication number 20100216896, to Wang, et al., teaches a gas-liquid-solid three-phase suspension bed reactor for Fischer-Tropsch synthesis. This consists of a three-phase suspension bed reactor with gas distributor, heat exchangers, liquid-solid filtration separation, flow guidance, condensate flux and separation, pressure stabilizers, and a cleaning system. The present disclosure differs from this disclosure in several ways readily apparent to those of normal skill in the art. Some of these differences are included here. The reactor does not remove vapor from the gas as a solid. The reactor is not cleaned by scouring with the fluidizing solids. The heat exchanger is used for controlling the temperature of the reaction, not for removing a vapor from a gas. The solids are used as catalysts and not for heat exchanger scouring. This disclosure is pertinent and may benefit from the devices disclosed herein and is hereby incorporated for reference in its entirety for all that it teaches.

### SUMMARY

A method for removing a vapor from a carrier gas is disclosed. A heat exchanger comprising a coolant side and a process side is provided. A coolant is provided to the coolant side. A slurry is provided to the process side. The slurry comprises a contact liquid and scouring solids. The carrier gas is provided to the heat exchanger, the carrier gas comprising a vapor. A portion of the vapor desublimates, condenses, absorbs, or reacts such that the portion of the vapor solidifies to form a product solid. At least a portion of the product solid deposits as a foulant on an outer surface of the coolant side. The outer surface of the coolant side of the heat exchanger is scoured with the scouring solids to remove the foulant from the outer surface of the coolant side. A vapor-depleted carrier gas is removed from the heat exchanger. The slurry and the product solid are removed from the heat exchanger. In this manner, the vapor is removed from the carrier gas.

The carrier gas may be provided by a plurality of gas injection inlets. A portion of the vapor-depleted carrier gas may be recycled to the plurality of gas injection inlets in varying proportions such that a temperature profile is effected in the heat exchanger.

The slurry and the product solid may be removed by introducing the slurry and the product solid to a screen, the screen having openings larger than an average size of the slurry and smaller than an average size of the scouring solids. A first portion of the product solid and a first portion of the contact liquid may pass through the screen and out of a product outlet of the heat exchanger. The scouring solids, a second portion of the product solid, and a second portion of the contact liquid may be prevented from passing through the screen and may be removed through a recycle outlet of the heat exchanger. The scouring solids, the second portion of the product solid, and the second portion of the contact liquid may be combined with a make-up portion of the contact liquid to form the slurry. The first portion of the product solid and the first portion of the contact liquid may be separated to produce a purified product and the make-up portion of the contact liquid.

The product solid may be removed from the slurry and the slurry may be reconstituted for recycle. The product solid removal may be accomplished by passing the slurry and product solid through a filter, producing a recycle contact liquid and a solid mixture, the solid mixture comprising the product solid and the scouring solids. The solid mixture may be separated, producing a purified product and dry scouring solids. The slurry may then be reconstituted by mixing the dry scouring solids with the recycle contact liquid to form the slurry.

The heat exchanger may comprise a shell and tube, plate, plate and frame, plate and shell, spiral, or plate fin style heat exchanger. The heat exchanger may further comprise a temperature sensor, a pressure sensor, a flow sensor, or a combination thereof. The heat exchanger may further comprise a pressure regulating device, a temperature regulating device, a flow regulating device, or a combination thereof. A programmable controller may be provided to control a feed rate of the carrier gas, a feed rate of the slurry, and a flow rate of the coolant.

The carrier gas may comprise flue gas, syngas, producer gas, natural gas, steam reforming gas, hydrocarbons, light gases, refinery off-gases, or combinations thereof. The vapor may comprise carbon dioxide, nitrogen oxide, sulfur dioxide, nitrogen dioxide, sulfur trioxide, hydrogen sulfide, hydrogen cyanide, water, mercury, hydrocarbons, or combinations thereof.

The scouring solids may comprise pellets, BBs, flakes, cylinders, randomly-shaped particles, or combinations thereof. The scouring solids may comprise metals, rocks, ceramics, a frozen form of the vapor, or combinations thereof.

The contact liquid may comprise any compound or mixture of compounds with a freezing point below a temperature at which the vapor condenses, desublimates, or a combination thereof. The contact liquid may comprise 1,1,3-trimethylcyclopentane, 1,4-pentadiene, 1,5-hexadiene, 1-butene, 1-methyl-1-ethylcyclopentane, 1-pentene, 5,3,3,3-tetrafluoropropene, 5,3-dimethyl-1-butene, 5-chloro-1,1,1,2-tetrafluoroethane, 5-methylpentane, 5-methyl-1,4-pentadiene, 5-methyl-1-butene, 5-methyl-1-pentene, 5-methylpentane, 4-methyl-1-hexene, 4-methyl-1-pentene, 4-methylcyclopentene, 4-methyl-trans-2-pentene, bromochlorodifluoromethane, bromodifluoromethane, bromotrifluoroethylene, chlorotrifluoroethylene, cis 5-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methylcyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, or combinations thereof.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a method for removing vapor from a carrier gas.

FIG. 2 shows a method for removing vapor from a carrier gas.

FIG. 3 shows a cross-section of a co-current heat exchanger for removing vapor from a carrier gas.

FIG. 4 shows a cross-section of a co-current heat exchanger for removing vapor from a carrier gas.

FIG. 5 shows a cross-section of a co-current heat exchanger for removing vapor from a carrier gas.

FIG. 6 shows a cross-section of a counter-current heat exchanger for removing vapor from a carrier gas.

FIG. 7 shows a cross-section of a cross-current heat exchanger for removing vapor from a carrier gas.

FIG. 8 shows a cross-section of a co-current heat exchanger for removing vapor from a carrier gas.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention.

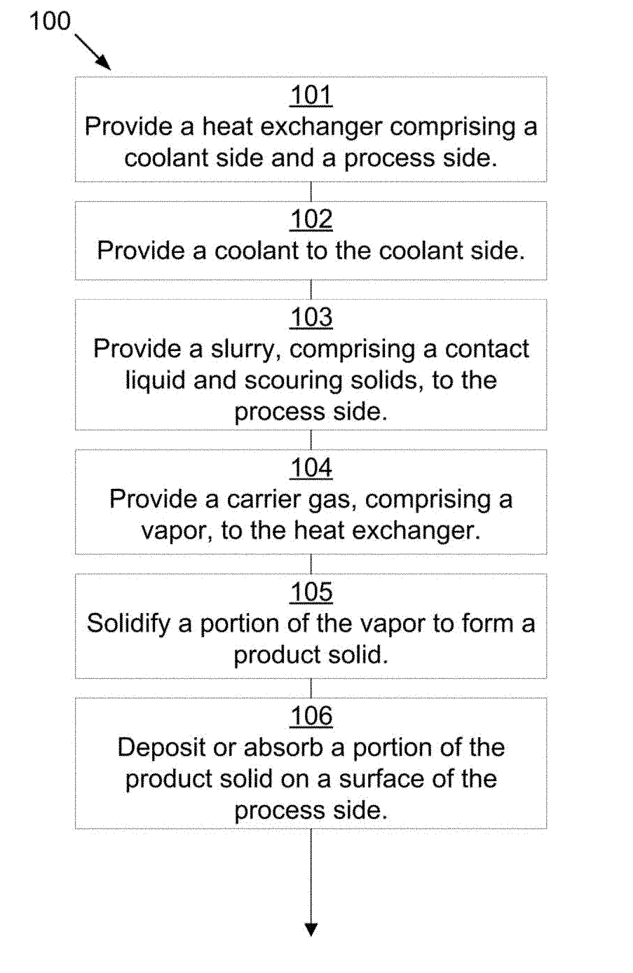

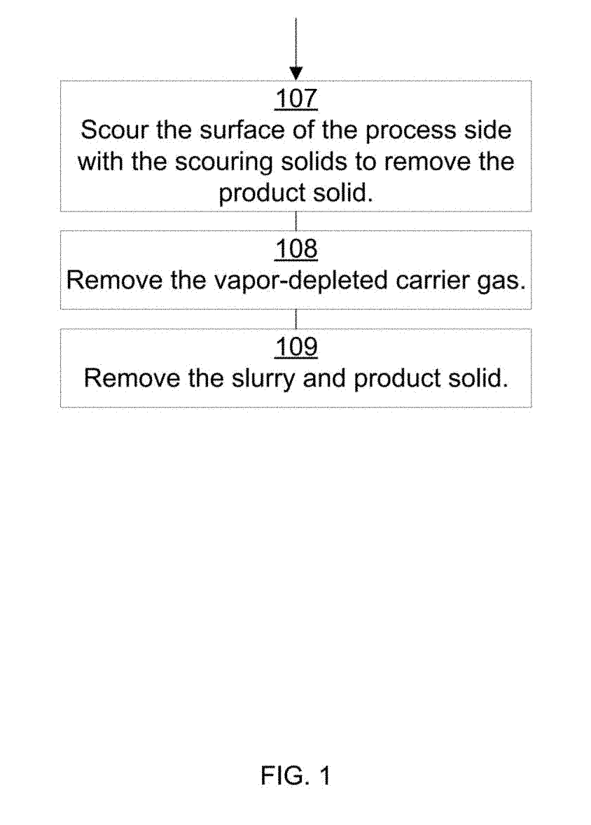

Referring to FIG. 1, a method for removing vapor from a carrier gas is shown at 100, as per one embodiment of the present invention. A heat exchanger, comprising a coolant side and a process side, is provided 101. A coolant is provided to the coolant side 102. A slurry is provided to the process side, the slurry comprising a contact liquid and scouring solids 103. The carrier gas is provided to the heat exchanger, the carrier gas comprising a vapor 104. A portion of the vapor desublimates, condenses, absorbs, or reacts such that the portion of the vapor solidifies to form a product solid 105. At least a portion of the product solid deposits as a foulant on an outer surface of the coolant side 106. The process side of the heat exchanger is scoured with the scouring solids to remove the foulant from the outer surface of the coolant side 107. A vapor-depleted carrier gas is removed from the heat exchanger 108. The slurry and product solid are removed from the heat exchanger 109.

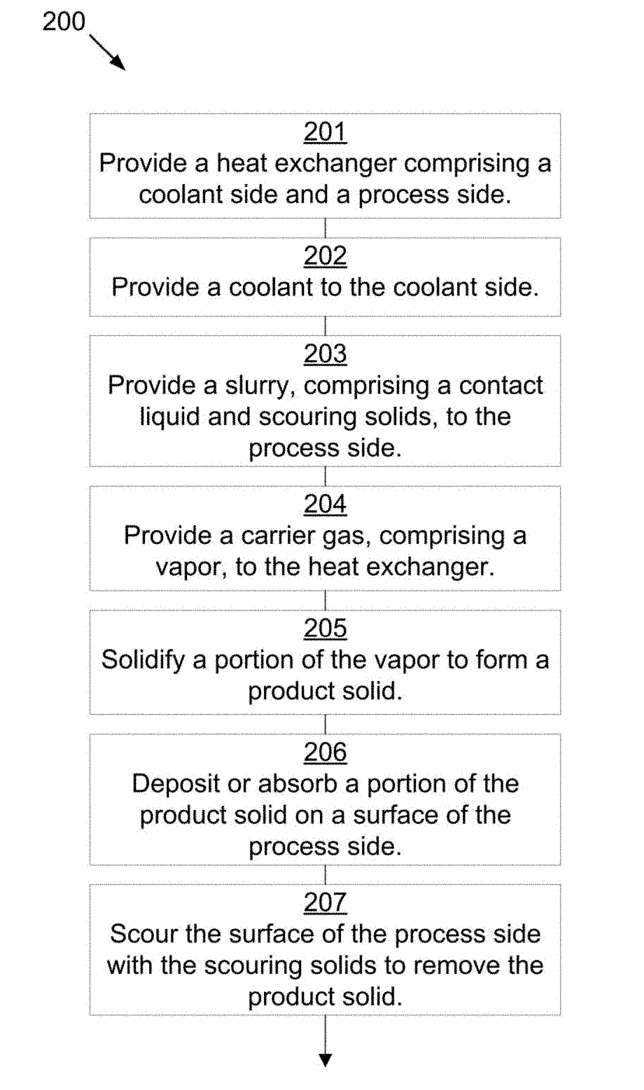

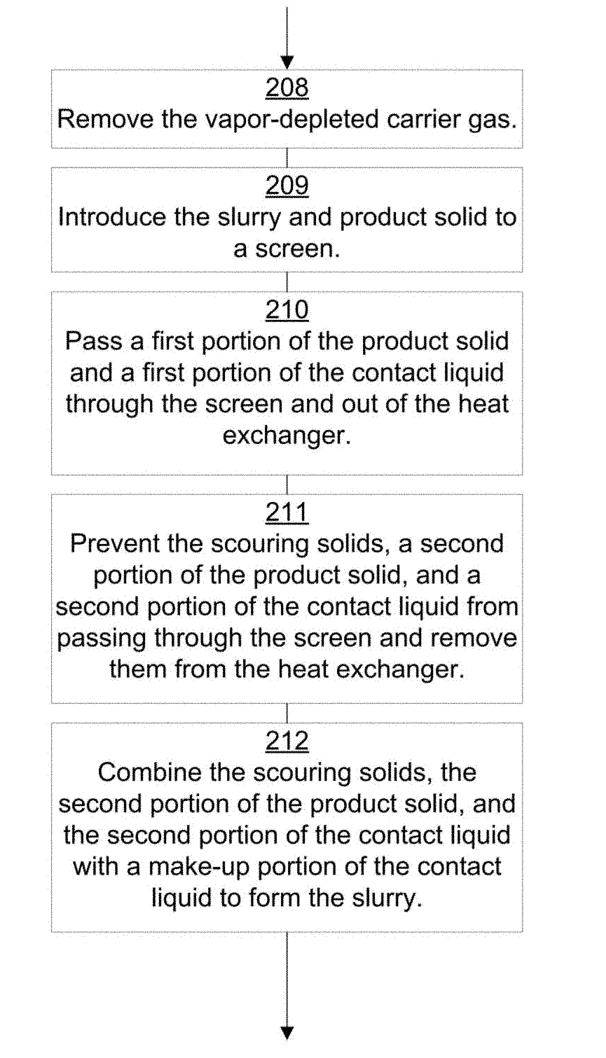

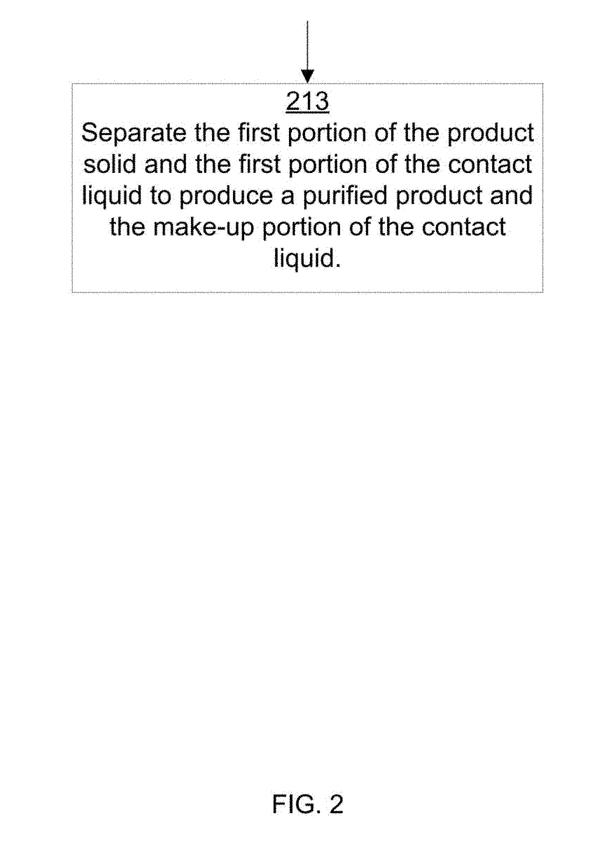

Referring to FIG. 2, a method for removing vapor from a carrier gas is shown at 200, as per one embodiment of the present invention. A heat exchanger, comprising a coolant side and a process side, is provided 201. A coolant is provided to the coolant side 202. A slurry is provided to the process side, the slurry comprising a contact liquid and scouring solids 203. The carrier gas is provided to the heat exchanger, the carrier gas comprising a vapor 204. A portion of the vapor desublimates, condenses, absorbs, or reacts such that the portion of the vapor solidifies to form a product solid 205. At least a portion of the product solid deposits as a foulant on an outer surface of the coolant side 206. The process side of the heat exchanger is scoured with the scouring solids to remove the foulant from the outer surface of the coolant side 207. A vapor-depleted carrier gas is removed from the heat exchanger 208. The slurry and the product solid introduced to a screen 209. The screen has openings smaller than an average size of the scouring solids and larger than an average size of the product solid. A first portion of the product solid and a first portion of the contact liquid passes through the screen and out of a product outlet of the heat exchanger 210. The scouring solids, a second portion of the product solid, and a second portion of the contact liquid are prevented from passing through the screen and are removed through a recycle outlet of the heat exchanger 211. The scouring solids, the second portion of the product solid, and the second portion of the contact liquid are combined with a make-up portion of the contact liquid to form the slurry, for recycle 212. The first portion of the product solid and the first portion of the contact liquid are separated to produce a purified product and the make-up portion of the contact liquid 213.

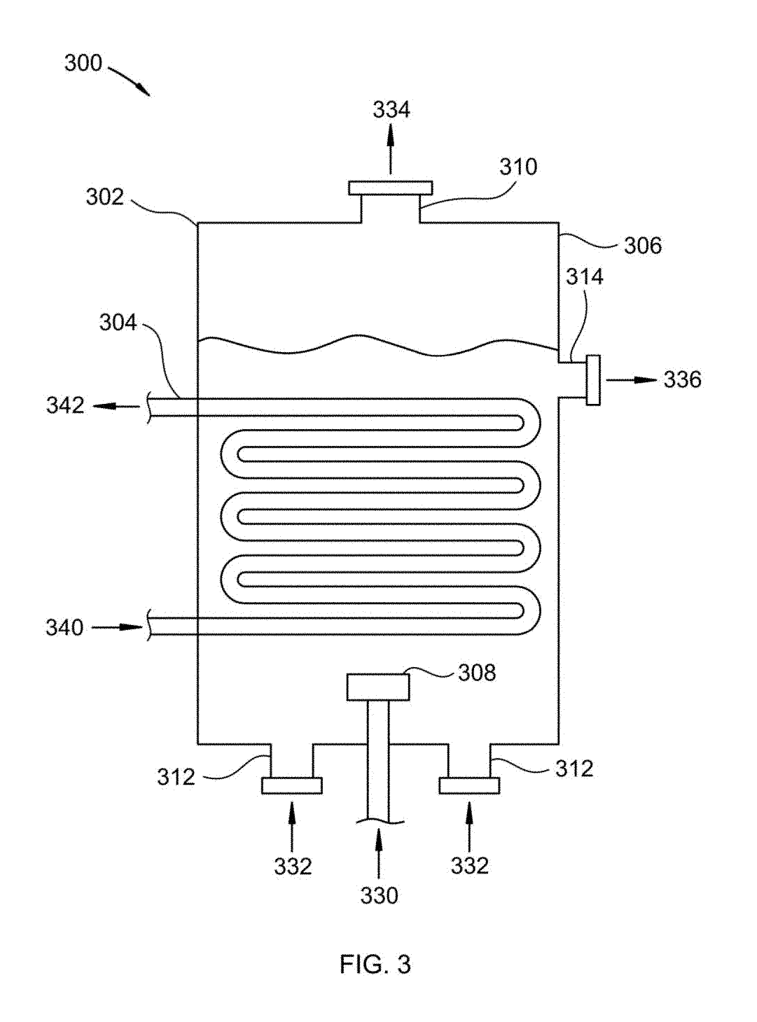

Referring to FIG. 3, a cross-section of a co-current three-phase scouring heat exchanger for removing vapor from a carrier gas is shown at 300, as per one embodiment of the present invention. Three-phase refers to the solids, liquids, and gases that pass through the exchanger. Exchanger 302 comprises tubes 304, shell 306, gas inlet 308, gas outlet 310, slurry inlets 312, and slurry outlet 314. Slurry 332, comprising a contact liquid and scouring solids, enters shell 306 through slurry inlets 312. Slurry 332 is cooled by coolant 340 through tubes 304. Carrier gas 330, comprising a vapor, is provided to shell 306 through gas inlet 308. A portion of the vapor is desublimated, condensed, absorbed, or reacted such that the portion of the vapor forms a product solid. A portion of the product solid deposits as a foulant on an outer surface of tubes 304. Due to the bubbling of carrier gas 330 and the path slurry 332 takes to pass across tubes 304, the scouring solids carried by slurry 332 pass across the outer surface of tubes 304, scouring and removing the foulant. Vapor-depleted carrier gas 334 is removed from exchanger 302 through gas outlet 310. Slurry 332 picks up the product solid, becoming product slurry 336. Product slurry 336 is removed from exchanger 302 through slurry outlet 314. In some embodiments, a cooling jacket is provided to the outside of exchanger 302 to supplement cooling from tubes 304.

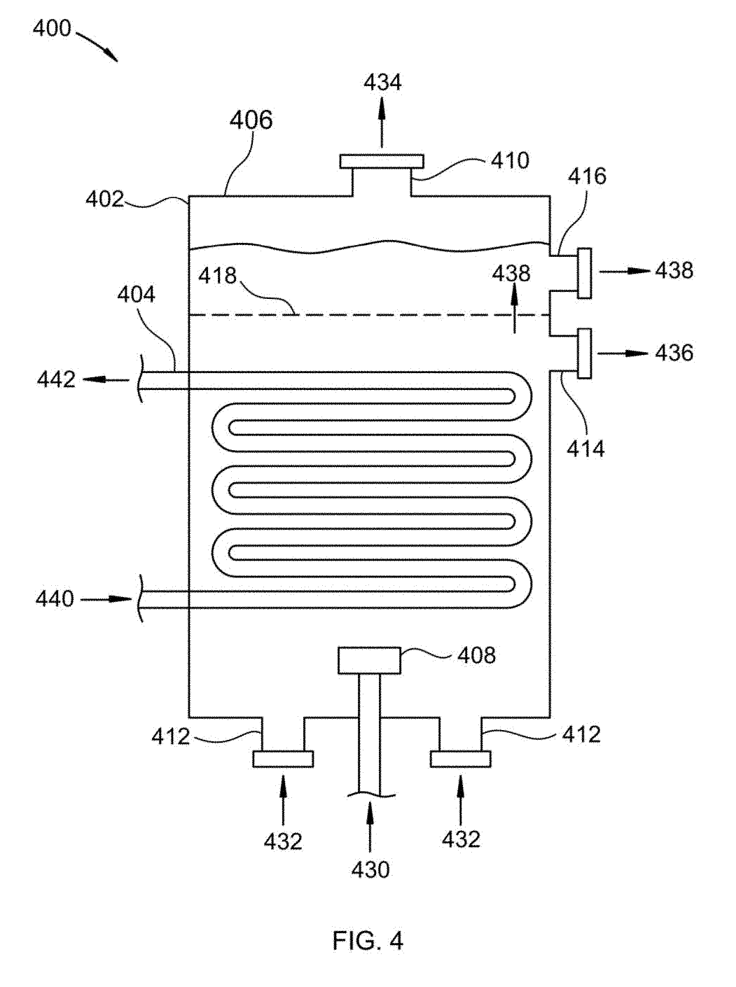

Referring to FIG. 4, a cross-section of a co-current three-phase scouring heat exchanger for removing vapor from a carrier gas is shown at 400, as per one embodiment of the present invention. Exchanger 402 comprises tubes 404, shell 406, bubbler 408, gas outlet 410, slurry inlets 412, first slurry outlet 414 and second slurry outlet 416. Slurry 432, comprising a contact liquid and scouring solids, enters shell 406 through slurry inlets 412. Slurry 432 is cooled by coolant 440 through tubes 404. Carrier gas 430, comprising a vapor, is provided to shell 406 through bubbler 408. A portion of the vapor is desublimated, condensed, absorbed, or reacted such that the portion of the vapor forms a product solid. A portion of the product solid deposits as a foulant on an outer surface of tubes 404. Due to the bubbling of carrier gas 430 and the path slurry 432 takes to pass across tubes 404, the scouring solids carried by slurry 432 pass across the outer surface of tubes 404, scouring and removing the foulant. Vapor-depleted carrier gas 434 is removed from exchanger 402 through gas outlet 410. Slurry 432 picks up the product solid and impinges on screen 418. Screen 418 has openings smaller than an average size of the scouring solids and larger than an average size of the product solid. A first portion of the product solid and a first portion of the contact liquid passes through screen 418 as second slurry product 438, leaving exchanger 402 through second slurry outlet 416. The scouring solids, a second portion of the product solid, and a second portion of the contact liquid are prevented from passing through screen 418 and are removed from exchanger 402 as first slurry product 436 through first slurry outlet 414. First slurry product 438 is combined with a make-up portion of the contact liquid to form slurry 432, which is recycled to inlets 412. Second slurry product 438 is separated to produce a purified product and the make-up portion of the contact liquid. Although first slurry product 438 contains a second portion of the product solid, this portion will reach equilibrium and stay constant as the scouring solids are repeatedly recycled. In some embodiments, a cooling jacket is provided to the outside of exchanger 402 to supplement cooling from tubes 404.

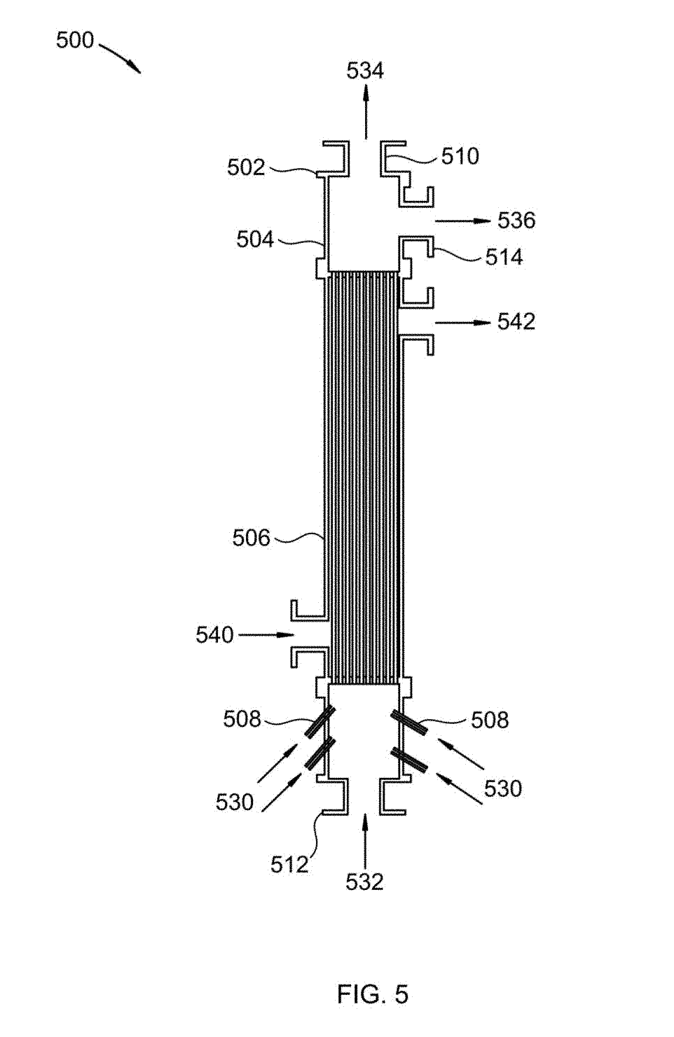

Referring to FIG. 5, a cross-section of a three-phase scouring co-current heat exchanger for removing vapor from a carrier gas is shown at 500, as per one embodiment of the present invention. Exchanger 502 comprises tube side 504, shell side 506, gas nozzles 508, gas outlet 510, slurry inlet 512, and slurry outlet 514. Slurry 532, comprising a contact liquid and scouring solids, enters tube side 504 through slurry inlet 512. Slurry 532 is cooled by coolant 540 through shell side 506. Carrier gas 530, comprising a vapor, is provided to tube side 504 through gas nozzles 508. A portion of the vapor is desublimated, condensed, absorbed, or reacted such that the portion of the vapor forms a product solid. A portion of the product solid deposits as a foulant on an inner surface of tube side 504. As slurry 532 passes through the tubes of tube side, the scouring solids carried by slurry 532 pass across the inner surface of tube side 504, scouring and removing the foulant. Vapor-depleted carrier gas 534 is removed from exchanger 502 through gas outlet 510. Slurry 532 picks up the product solid, becoming product slurry 536. Product slurry 536 is removed from exchanger 502 through slurry outlet 514. In some embodiments, slurry inlet 512 is switched with slurry outlet 514, making exchanger 502 a counter-current heat exchanger.

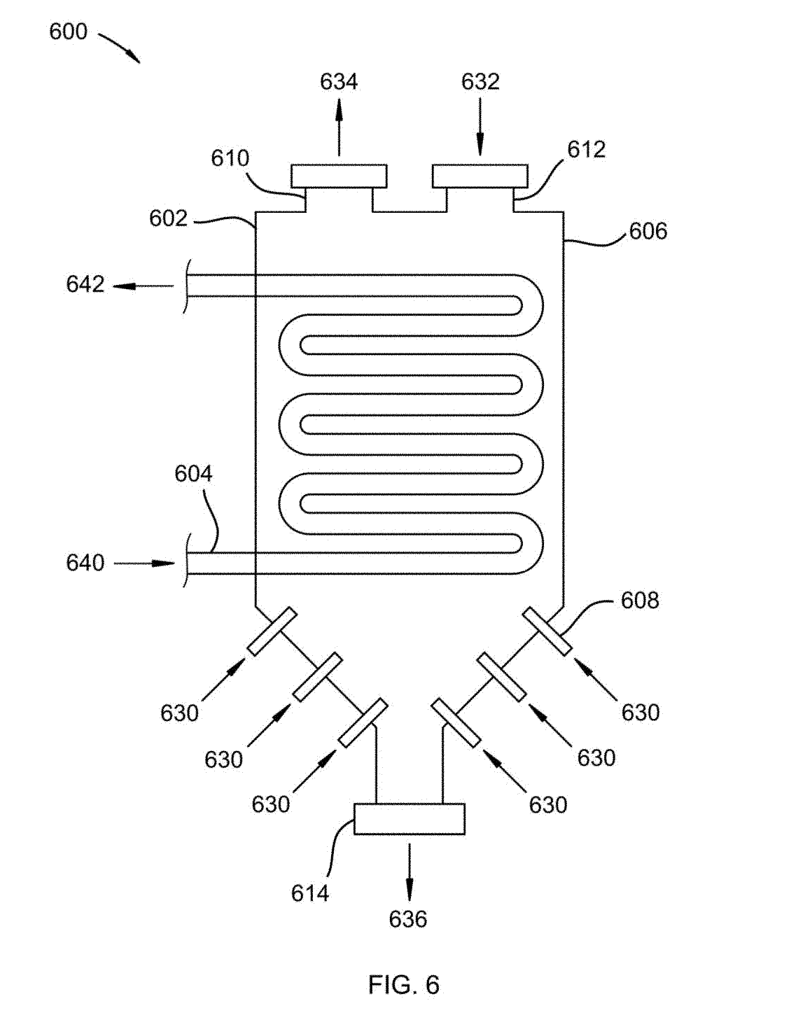

Referring to FIG. 6, a cross-section of a three-phase scouring counter-current heat exchanger for removing vapor from a carrier gas is shown at 600, as per one embodiment of the present invention. Exchanger 602 comprises tubes 604, shell 606, gas nozzles 608, gas outlet 610, slurry inlet 612, and slurry outlet 614. Slurry 632, comprising a contact liquid and scouring solids, enters shell 606 through slurry inlets 612. Slurry 632 is cooled by coolant 640 through tubes 604. Carrier gas 630, comprising a vapor, is provided to shell 606 through gas nozzles 608. A portion of the vapor is desublimated, condensed, absorbed, or reacted such that the portion of the vapor forms a product solid. A portion of the product solid deposits as a foulant on an outer surface of tubes 604. Due to the bubbling of carrier gas 630 and the path slurry 632 takes to pass across tubes 604, the scouring solids carried by slurry 632 pass across the outer surface of tubes 604, scouring and removing the foulant. Vapor-depleted carrier gas 634 is removed from exchanger 602 through gas outlet 610. Slurry 632 picks up the product solid, becoming product slurry 636. Product slurry 636 is removed from exchanger 602 through slurry outlet 614. In some embodiments, a cooling jacket is provided to the outside of exchanger 602 to supplement cooling from tubes 604.

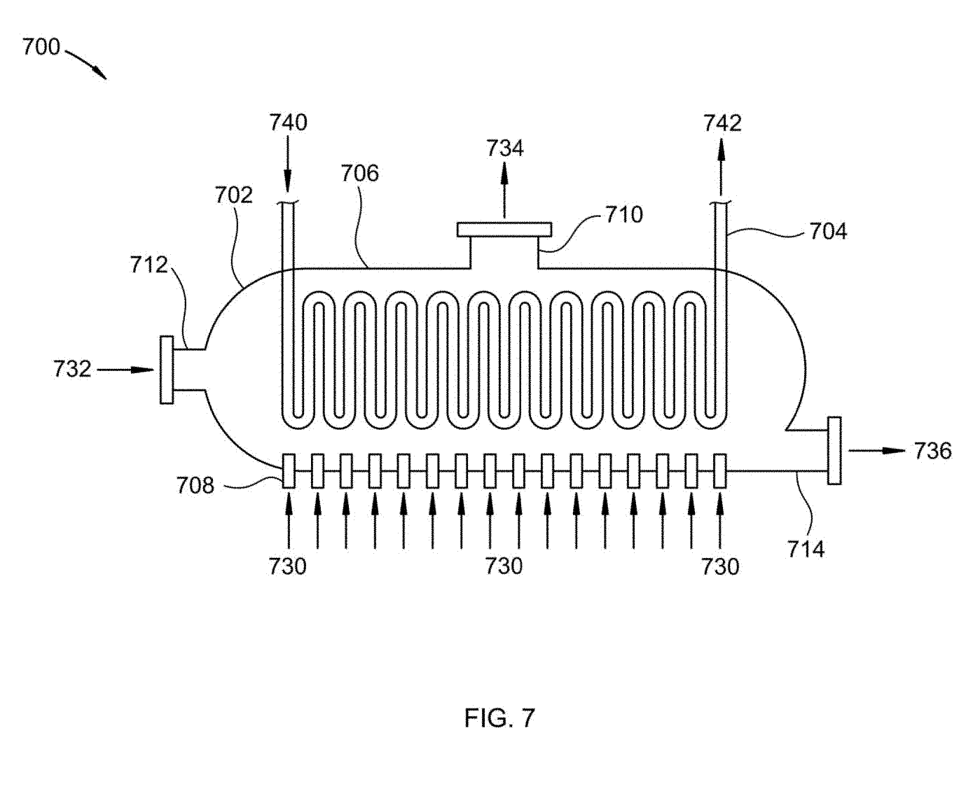

Referring to FIG. 7, a cross-section of a cross-flow three-phase scouring heat exchanger for removing vapor from a carrier gas is shown at 700, as per one embodiment of the present invention. Exchanger 702 comprises tubes 704, shell 706, gas nozzles 708, gas outlet 710, slurry inlet 712, and slurry outlet 714. Slurry 732, comprising a contact liquid and scouring solids, enters shell 706 through slurry inlets 712. Slurry 732 is cooled by coolant 740 through tubes 704. Carrier gas 730, comprising a vapor, is provided to shell 706 through gas nozzles 708. A portion of the vapor is desublimated, condensed, absorbed, or reacted such that the portion of the vapor forms a product solid. A portion of the product solid deposits as a foulant on an outer surface of tubes 704. Due to the bubbling of carrier gas 730 preventing settling of any solids and the path slurry 732 takes to pass across tubes 704, the scouring solids carried by slurry 732 pass across the outer surface of tubes 704, scouring and removing the foulant. Vapor-depleted carrier gas 734 is removed from exchanger 702 through gas outlet 710. Slurry 732 picks up the product solid, becoming product slurry 736. Product slurry 736 is removed from exchanger 702 through slurry outlet 714. In some embodiments, a cooling jacket is provided to the outside of exchanger 702 to supplement cooling from tubes 704. In some embodiments, a portion of vapor-depleted carrier gas 734 is recycled to gas nozzles 708, with varying proportions of recycle provided to gas nozzles 708 such that a temperature profile is effected in the heat exchanger.

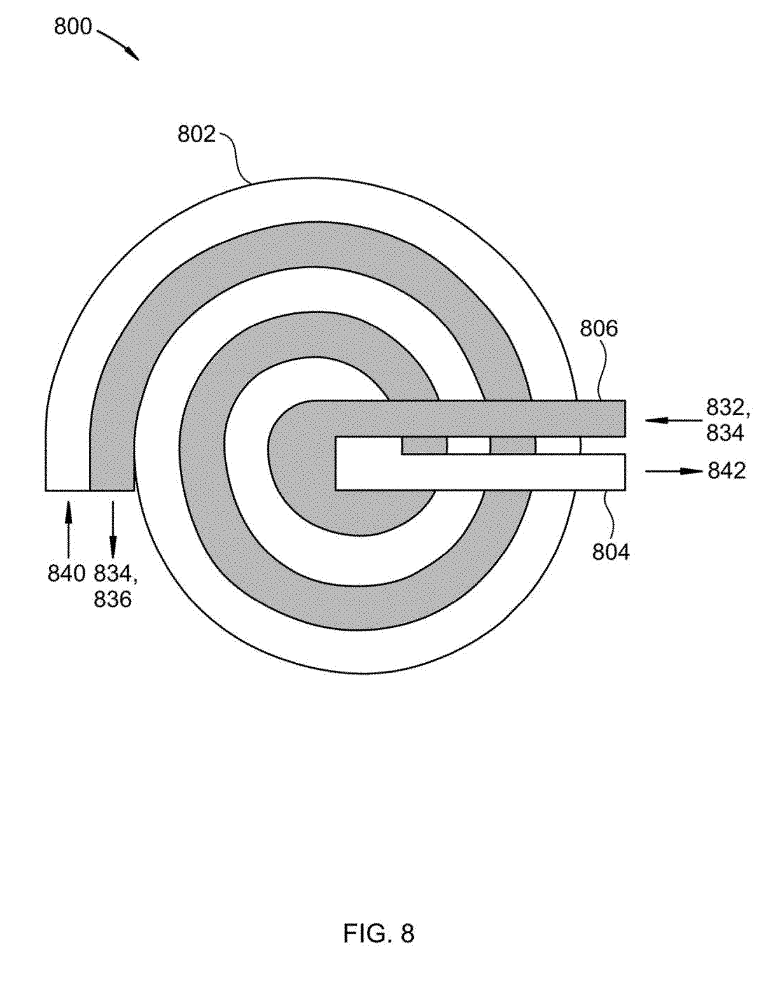

Referring to FIG. 8, a cross-section of a co-current three-phase scouring heat exchanger for removing vapor from a carrier gas is shown at 800, as per one embodiment of the present invention. Spiral exchanger 802 comprises coolant side 804 and process side 806. Slurry 832, comprising a contact liquid and scouring solids, and carrier gas 834, comprising a vapor, enter process side 806 and are cooled by coolant 840. A portion of the vapor is desublimated, condensed, absorbed, or reacted such that the portion of the vapor forms a product solid. A portion of the product solid deposits as a foulant on a wall of process side 806 in contact with coolant side 804. Due to the path slurry 832 takes through process side 806, the scouring solids carried by slurry 832 pass across the wall of process side 806, scouring and removing the foulant. Slurry 832 picks up the product solid, becoming product slurry 836. Vapor-depleted carrier gas 834 and product slurry 836 are removed from spiral exchanger 802. Vapor-depleted carrier gas 834 and product slurry 836 are then separated. In some embodiments, the product solid is removed from the slurry and the slurry is reconstituted for recycle to the process. In some embodiments, this removal step is accomplished by passing the slurry and product solid through a filter, producing a recycle contact liquid and a solid mixture. The solid mixture comprises the product solid and the scouring solids. The solid mixture is then separated, producing a purified product and dry scouring solids. The slurry is reconstituted by mixing the dry scouring solids with the recycle contact liquid to form the slurry.

In some embodiments, the heat exchanger comprises a shell and tube, plate, plate and frame, plate and shell, spiral, or plate fin style heat exchanger. In some embodiments, the heat exchanger further comprises a temperature sensor, a pressure sensor, a flow sensor, or a combination thereof. In some embodiments, the heat exchanger further comprises a pressure regulating device, a temperature regulating device, a flow regulating device, or a combination thereof. In some embodiments, a programmable controller is provided to control a feed rate of the carrier gas, a feed rate of the slurry, and a flow rate of the coolant.

In some embodiments, the carrier gas comprises flue gas, syngas, producer gas, natural gas, steam reforming gas, hydrocarbons, light gases, refinery off-gases, or combinations thereof. In some embodiments, the vapor comprises carbon dioxide, nitrogen oxide, sulfur dioxide, nitrogen dioxide, sulfur trioxide, hydrogen sulfide, hydrogen cyanide, water, mercury, hydrocarbons, or combinations thereof.

In some embodiments, the scouring solids comprise pellets, BBs, flakes, cylinders, randomly-shaped particles, or combinations thereof. In some embodiments, the scouring solids comprise metals, rocks, ceramics, a frozen form of the vapor, or combinations thereof.

In some embodiments, the contact liquid comprises any compound or mixture of compounds with a freezing point above a temperature at which the vapor condenses, desublimates, or a combination thereof. In some embodiments, the contact liquid comprises 1,1,3-trimethylcyclopentane, 1,4-pentadiene, 1,5-hexadiene, 1-butene, 1-methyl-1-ethylcyclopentane, 1-pentene, 5,3,3,3-tetrafluoropropene, 5,3-dimethyl-1-butene, 5-chloro-1,1,1,2-tetrafluoroethane, 5-methylpentane, 5-methyl-1,4-pentadiene, 5-methyl-1-butene, 5-methyl-1-pentene, 5-methylpentane, 4-methyl-1-hexene, 4-methyl-1-pentene, 4-methylcyclopentene, 4-methyl-trans-2-pentene, bromochlorodifluoromethane, bromodifluoromethane, bromotrifluoroethylene, chlorotrifluoroethylene, cis 5-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methylcyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, or combinations thereof.

Combustion flue gas consists of the exhaust gas from a fireplace, oven, furnace, boiler, steam generator, or other combustor. The combustion fuel sources include coal, hydrocarbons, and biomass. Combustion flue gas varies greatly in composition depending on the method of combustion and the source of fuel. Combustion in pure oxygen produces little to no nitrogen in the flue gas. Combustion using air leads to the majority of the flue gas consisting of nitrogen. The non-nitrogen flue gas consists of mostly carbon dioxide, water, and sometimes unconsumed oxygen. Small amounts of carbon monoxide, nitrogen oxides, sulfur dioxide, hydrogen sulfide, and trace amounts of hundreds of other chemicals are present, depending on the source. Entrained dust and soot will also be present in all combustion flue gas streams. The method disclosed applies to any combustion flue gases. Dried combustion flue gas has had the water removed.

Syngas consists of hydrogen, carbon monoxide, and carbon dioxide.

Producer gas consists of a fuel gas manufactured from materials such as coal, wood, or syngas. It consists mostly of carbon monoxide, with tars and carbon dioxide present as well.

Steam reforming is the process of producing hydrogen, carbon monoxide, and other compounds from hydrocarbon fuels, including natural gas. The steam reforming gas referred to herein consists primarily of carbon monoxide and hydrogen, with varying amounts of carbon dioxide and water.

Light gases include gases with higher volatility than water, including hydrogen, helium, carbon dioxide, nitrogen, and oxygen. This list is for example only and should not be implied to constitute a limitation as to the viability of other gases in the process. A person of skill in the art would be able to evaluate any gas as to whether it has higher volatility than water.

Refinery off-gases comprise gases produced by refining precious metals, such as gold and silver. These off-gases tend to contain significant amounts of mercury and other metals.

1. A method for removing a vapor from a carrier gas comprising:
providing a heat exchanger comprising a coolant side and a process side;
providing a coolant to the coolant side;
providing a slurry to the process side, the slurry comprising a contact liquid and scouring solids;
providing the carrier gas to the heat exchanger, the carrier gas comprising a vapor;
desublimating, condensing, absorbing, or reacting a portion of the vapor such that the portion of the vapor solidifies to form a product solid, at least a portion of the product solid depositing as a foulant on an outer surface of the coolant side;
scouring the outer surface of the coolant side of the heat exchanger with the scouring solids to remove the foulant from the outer surface of the coolant side;
removing a vapor-depleted carrier gas from the heat exchanger; and,
removing the slurry and product solid from the heat exchanger;
whereby the vapor is removed from the carrier gas.

2. The method of claim 1, wherein the providing the carrier gas step is accomplished by a plurality of gas injection inlets.

3. The method of claim 2, further comprising recycling a portion of the vapor-depleted carrier gas to the plurality of gas injection inlets in varying proportions such that a temperature profile is effected in the heat exchanger.

4. The method of claim 1, wherein the removing the slurry and the product solid step is accomplished by introducing the slurry and the product solid to a screen, the screen having openings larger than an average size of the slurry and smaller than an average size of the scouring solids, wherein a first portion of the product solid and a first portion of the contact liquid passes through the screen and out of a product outlet of the heat exchanger, and, wherein the scouring solids, a second portion of the product solid, and a second portion of the contact liquid are prevented from passing through the screen and are removed through a recycle outlet of the heat exchanger.

5. The method of claim 4, further comprising combining the scouring solids, the second portion of the product solid, and the second portion of the contact liquid with a make-up portion of the contact liquid to form the slurry.

6. The method of claim 5, further comprising separating the first portion of the product solid and the first portion of the contact liquid to produce a purified product and the make-up portion of the contact liquid.

7. The method of claim 1, further comprising removing the product solid from the slurry and reconstituting the slurry for recycle.

8. The method of claim 7, wherein the removing the product solid step is accomplished by passing the slurry and product solid through a filter, producing a recycle contact liquid and a solid mixture, the solid mixture comprising the product solid and the scouring solids.

9. The method of claim 8, further comprising separating the solid mixture, producing a purified product and dry scouring solids.

10. The method of claim 9, wherein the reconstituting the slurry step comprises mixing the dry scouring solids with the recycle contact liquid to form the slurry.

11. The method of claim 1, providing the heat exchanger comprising a shell and tube, plate, plate and frame, plate and shell, spiral, or plate fin style heat exchanger.

12. The method of claim 11, providing the heat exchanger further comprising a temperature sensor, a pressure sensor, a flow sensor, or a combination thereof.

13. The method of claim 12, providing the heat exchanger further comprising a pressure regulating device, a temperature regulating device, a flow regulating device, or a combination thereof.

14. The method of claim 13, further comprising providing a programmable controller to control a feed rate of the carrier gas, a feed rate of the slurry, and a flow rate of the coolant.

15. The method of claim 1, providing the carrier gas comprising flue gas, syngas, producer gas, natural gas, steam reforming gas, hydrocarbons, light gases, refinery off-gases, or combinations thereof.

16. The method of claim 15, providing the vapor comprising carbon dioxide, nitrogen oxide, sulfur dioxide, nitrogen dioxide, sulfur trioxide, hydrogen sulfide, hydrogen cyanide, water, mercury, hydrocarbons, or combinations thereof.

17. The method of claim 1, providing the scouring solids comprising pellets, BBs, flakes, cylinders, randomly-shaped particles, or combinations thereof.

18. The method of claim 1, providing the scouring solids comprising metals, rocks, ceramics, a frozen form of the vapor, or combinations thereof.

19. The method of claim 1, providing the contact liquid comprising any compound or mixture of compounds with a freezing point above a temperature at which the vapor condenses, desublimates, or a combination thereof.

20. The method of claim 1, providing the contact liquid further comprising 1,1,3-trimethylcyclopentane, 1,4-pentadiene, 1,5-hexadiene, 1-butene, 1-methyl-1-ethylcyclopentane, 1-pentene, 5,3,3,3-tetrafluoropropene, 5,3-dimethyl-1-butene, 5-chloro-1,1,1,2-tetrafluoroethane, 5-methylpentane, 5-methyl-1,4-pentadiene, 5-methyl-1-butene, 5-methyl-1-pentene, 5-methylpentane, 4-methyl-1-hexene, 4-methyl-1-pentene, 4-methylcyclopentene, 4-methyl-trans-2-pentene, bromochlorodifluoromethane, bromodifluoromethane, bromotrifluoroethylene, chlorotrifluoroethylene, cis 5-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methylcyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, or combinations thereof.
